(19) United States
(12) Patent Application Publication
(10) Pub. No.: US 2011/0109165 A1
(43) Pub. Date: May 12, 2011

(54) APPARATUS AND METHOD FOR MANAGING A POWER SOURCE

(75) Inventors: Peter Hahn, Berlin (DE); Nils Haustein, Mainz (DE); Rainer Krause, Mainz (DE)

(73) Assignee: International Business Machines Corporation, Armonk, NY (US)

(21) Appl. No.: 12/825,434

(22) Filed: Jun. 29, 2010

(30) Foreign Application Priority Data
Nov. 11, 2009 (DE) EP09175636

(51) Int. Cl. H02J 4/00

(52) U.S. Cl. 307/72

(57) ABSTRACT

An electrical power management apparatus and method in which a public power grid, a renewable energy source, an energy storage element and a domestic power supply network are interconnected through a controllable switch which connects the various components together in combinations which are advantageous to sensed power load and consumption circumstances.

### FIELD AND BACKGROUND OF THE INVENTION

The present invention relates to the field of managing power sources, specifically to the field of managing renewable energy sources by using power storage devices and grid load measurements.

Managing power sources, especially renewable energy sources such as wind or solar power, is of high relevance in common power grids. US2008/0195255 A1 discloses a utility grid comprising a centralized control means, an intermittent renewable energy source for generating electrical power, at least one further power generation system and at least one local controller for controlling the total power output of said intermittent renewable energy source and said at least one further power generation system.

### SUMMARY OF THE INVENTION

The present invention provides an apparatus and a method for managing a power source connected to a public power grid.

According to embodiments of the invention the apparatus comprises a first connector for connecting to a public power grid, a second connector for connecting to a power source, a third connector for connecting to a power storage and a fourth connector for connecting to a domestic power supply network. As used here, the phrase “domestic power supply” refers to the power supply system or network within a building such as a home or office. The power source may be a renewable energy power source such as a wind or solar power source. The power storage may be for example a rechargeable battery, a plurality of rechargeable batteries or a hydrogen storage. The hydrogen in the storage can be produced by the electrolysis of water.

The apparatus comprises a controllable switch, which is coupled to the first, second, third and fourth connectors. The switch can be switched between a plurality of switching positions, each switching position connecting two of the first, second, third and fourth connectors.

The apparatus comprises a power line communication module for establishing a communication link via the public power grid. The power line communication module is adapted to receive a control signal. In a preferred embodiment the communication link via the public power grid is established to the public power grid provider. The control signal is then received by the public power grid provider.

Furthermore, the apparatus comprises a logic component coupled to the power line communication module and to a control input of the controllable switch. The logic component is operable to process the control signal and to perform one of several steps depending on a result of the processing of the control signal. In other words, this means that the logic component can receive the control signal from the power line communication module and that the logic component controls the switching of the controllable switch.

The controllable switch can be set such that the power source is connected to the public power grid. This switch setting is used for sourcing power to the public power grid from the power source. In a second position the controllable switch is set such that the power source is connected to the power storage. This switch setting is used for sourcing power to the power storage from the power source. In a third position the controllable switch is set such that the power source is connected to the domestic power supply network. In the domestic power supply network there are a plurality of local electrical devices consuming power. In a fourth position the controllable switch is set such that the power storage is connected to the domestic power supply network. This means that the local electrical devices are supplied with power from the power storage. In a fifth position the controllable switch is set such that the power storage is connected to the public power grid. This switch setting is used for sourcing power to the public power grid from the power storage. In a sixth position the controllable switch is set such that the public power grid is connected to the domestic power supply network. This means that the local electrical devices are supplied with power from the power grid.

### BRIEF DESCRIPTION OF THE DRAWINGS

Some of the purposes of the invention having been stated, others will appear as the description proceeds, when taken in connection with the accompanying drawings, in which:

FIG. 1 is a schematic view of an apparatus connected to a public power grid;

FIG. 2 is a schematic view of a plurality of apparatuses connected to a public power grid; and

FIG. 3 is a block diagram of peak load management method.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

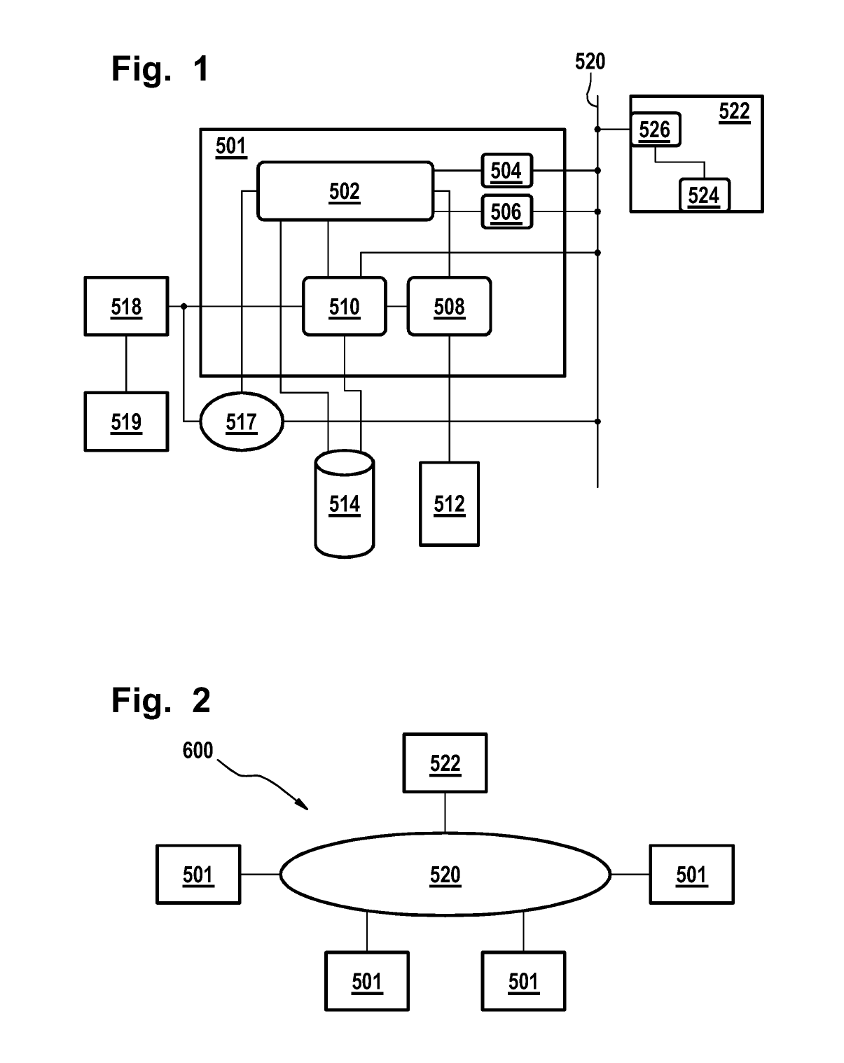

Referring now to FIG. 1, the apparatus 501 is connected to a power source 512, a power storage 514, a public power grid 520 and a domestic power supply network 518. The apparatus 501 comprises a control logic 502, a power line communication module 504, a grid load measurement module 506, a power inverter 508 and a controllable switch 510.

According to the first switch setting the power source 512 is connected to the public power grid 520. This means that power produced by the power source is supplied to the public power grid. This is advantageous because the user may not need the energy produced by the power source in his own domestic power supply network or in the power storage. Thus, sourcing the produced power to the public power grid is useful for not wasting the produced power and for supporting the peak management in the power grid. According to the second switch setting the power source 512 is connected to the power storage 514. This means, that the power produced by the power source is supplied to the power storage. This is advantageous when the user does not need the produced power in his domestic power supply network but he may want to use the power later in his domestic power supply network. According to the third switch setting the power source 512 is connected to the domestic power supply network 518. This is advantageous because the power produced by the power source is supplied to the domestic power supply network and used by the local electrical devices connected to the domestic power supply network. According to the fourth switch setting of the controllable switch the power storage 514 is connected to the domestic power supply network 518. This is advantageous because the power stored in the power storage is supplied to the domestic power supply network and used by the local electrical devices. The power stored in the power storage may for example have been produced by the power source at an earlier point of time. According to the fifth switch setting the power storage 514 is connected to the public power grid 520. This is advantageous for example if the load of the public power grid is high and additional power is needed. According to the sixth switch setting the public power grid 520 is connected to the domestic power supply network 518. This is advantageous when the power storage and the power source do not supply enough power for the local electrical devices.

The logic component 502 is adapted to perform methods for controlling the operation of the apparatus. The apparatus 501 is connected to a power source 512, for example a photovoltaic solar unit which produces electrical power. The power source is connected to the inverter 508 which converts DC in AC power. The AC power is directed to the controllable switch 510 which is controlled by the logic component 502. Switch 510 switches the AC power between the public power grid 520, the power storage 514 and the domestic power supply network 518 based on instructions of the logic component 502.

According to embodiments of the invention the apparatus comprises a grid load measurement module 506, which measures the grid load of the public power grid 520 by measuring the frequency of the public power grid. If the grid frequency decreases, this indicates a high grid load, and if the frequency increases this means that the grid load decreases. Thus, by measuring the frequency the grid load can be determined at the user side for example. Another possibility is to measure the grid load at the provider side and to send a provider signal to the user. The provider signal is indicative of the grid load. In common European power grids the frequency varies between 49.5 Hz and 50.5 Hz. In common American power grids the frequency is higher, ranging around 60 Hz.

The logic component 502 is also connected to the grid load measurement module 506 which measures the frequency on the public power grid 520 and sends the results to the logic component 502. The gird load measurement module 506 is also able to identify potential power losses on the public power grid 520. The logic component 502 is also connected to a power line communication module 504 which is adapted for bidirectional data communication between the apparatus 501 and an apparatus 522 of the power grid provider via the public power grid 520. The logic component 502 is connected to the inverter 508 in order to obtain the power status including the amount of power being produced by the power source 512. The logic component 502 is also connected to the power storage 514 which is used to store power, for example in case of low power grid network demands. Via this connection the logic component 502 is able to identify the load status of the power storage 514. The power storage 514 might be represented by a battery. The logic component 502 is also connected to electric meter 517 which measures the power consumed from the power grid. Via this connection the control logic 502 is able to obtain the power consumption within a certain time period.

A provider unit 522 of the power grid provider sources the power generated by a power plant to the public power grid 520. The provider unit 522 of the power grid provider comprises a provider logic 524 which is connected to a power line communication module 526 which is used for bidirectional data communication between the provider and the apparatus 501. This means the bidirectional communication enables a status request from the provider.

Local power consuming electrical devices 519 are connected to the domestic power supply network 518 and consume power which is either provided by the power source 512 or the public power grid 520.

In operation, the logic component 502 controls the switch 510 in dependency on a control signal received from the provider unit 522 via power line communication module 504. First, the provider logic 526 analyzes the power load on the public power grid 520 and determines if the load is higher than a first threshold. If the load is higher than the first threshold the provider logic sends a control signal via power line communication module 526 to the apparatus 501 instructing the apparatus 501 to source power to the public power grid 520.

After having received the control signal via the power line communication module 504, the logic component 502 determines load status of the power storage 514. If the load status is below a second threshold the logic component 502 sets the switch 510 such that the power storage 514 is connected to the power source 512, causing the power storage 514 to be recharged with power from power source 512. Preferably, the second threshold is in the range of 15-25% of the power storage's 514 capacity.

If the load status of the power storage 514 is above the second threshold the logic component 502 controls the switch 510 such that the power source 512 is connected to the public power grid 520, causing the power generated by the power source 512 to be sourced to the public power grid via inverter 508.

The analysis of the power load can be based on frequency of the current in the power grid 520. A high frequency means low power load and a low frequency means high power load according to methods pertaining to prior art.

According to embodiments of the invention the logic component 502 determines a time period in which a power line communication module has not received a control signal. This may be due to the fact of communication problems or due to the fact that the public power grid provider does not support sending a suitable control signal to the logic component. The logic component requests a power grid status of the public power grid if this time period is longer than a threshold. The power grid status can for example be requested from the grid load measurement module. The grid load measurement module measures the frequency and calculates the grid load based on the measured frequency. This information can be also send by the provider, this to manage peak on a larger scale.

Further, the logic component 502 determines when the last command was received from the provider unit 522 and compares if this time period is larger than a third threshold. If the time period is larger than the third threshold logic component 502 sends a command to the provider logic 526 via the power line communication module 504 requesting the provider status and determines if the provider unit 522 does not respond within a certain time period. If the provider unit 522 does not respond within this time period the logic component 502 obtains the frequency status from the grid load measurement module 506 and determines if the frequency is below a fourth threshold. The provider might also send a status request via the bidirectional power line communication.

If the frequency is below the fourth threshold the logic component 502 checks if the load status of the power storage 514 is above a fifth threshold. Preferably, the fifth threshold is in the range of 15-25% of the power storage's 514 capacity. If the load status of the power storage 514 is above the fifth threshold, the logic component 502 sets the switch 510 such that the public power grid 520 is connected to the power storage 514 to supply power to the public power grid 520. If the load status of the power storage 514 is below the fifth threshold then the logic component 502 sets the switch 510 such that the power storage 514 is connected to the power source 512.

According to embodiments of the invention the control signal comprises a power schedule. The power schedule is indicative of periodic times of various power load levels of the public power grid. Therefore the public power grid provider analyzes the power load on the power grid for a certain period of time and determines repeating times with low power loads and high power loads on the power grid which is summarized in the power schedule. Thus, the logic component knows about certain periods of time with high and low power loads and can control the controllable switch in dependency on these predetermined power loads. For example, the switch is set to source power from the power source to the public power grid because of a high grid load and the power schedule indicates a low power load for the next time period, for example several minutes or even hours, the logic component may set the switch to supply power from the power source to the power storage for example. The fixed schedule is based on historical data. The schedule can be adapted over time by adjusting to the new data available. For example, the schedule comprises historical times with high and low power loads. Thus, from this schedule periodic times of high and low power loads can be determined.

In another embodiment, the provider logic 524 analyzes the power load on the power grid 520 for a certain period of time and determines repeating times with low power loads and high power loads on the power grid which is summarized in power schedules. The power schedule comprises time ranges and instructions about when to supply power to the power grid and when not to supply power to the power grid.

According to embodiments of the invention the method further comprises receiving a power schedule. The power schedule is indicative of periodic times of various power levels of the public power grid. By having received the power schedule the control logic can control the controllable switch based on the power schedule. For example, the power schedule indicates a low power load after a high power load, then the control logic switches the switch to an advantageous position.

The provider logic sends the power schedule via the power line communication module 526 to the apparatus 501 and more particularly to the power line communication module 504 which passes the schedules on to the logic component 502. The logic component 502 stores the power schedule in an internal non-volatile memory.

The logic component 502 has an internal clock and executes the power schedule by comparing the times indicated in the power schedule with the current time of the internal clock. The logic component 502 determines if the instruction associated with the time is to supply power to the public power grid 520. If so, the logic component 502 controls the switch 510 such that the power source 512 is connected to the public power grid 520.

If the instruction is not to supply power to the public power grid 520 the control logic determines if the load status of the power storage 514 is above the fifth threshold. If so, the logic component 502 controls the switch 510 such that the domestic power supply network 518 is connected to the power source 512. Thus, power is supplied directly from the power source 512 to the local electrical devices 519.

If the load status of the power storage 514 is below the fifth threshold the logic component 502 controls the switch 510 such that the power source 512 is connected to the power storage 514 and the power storage 514 is recharged.

It is to be noted that the steps that are performed after having received the power schedule could also have been performed after having received the control signal from the provider or after the grid load measurement module 504 has measured the grid load. The same steps can also be performed dependent on a user's decision.

Another application possibility is to use embodiments of the invention also for tariff based power management. The logic component 502 obtains tariff information from the provider unit 522 via the power line communication modules 504 and 526. Such tariff information comprises at least a unit cost for power obtained from the public power grid 520 and a unit price for power supplied to the public power grid 520.

The logic component determines if the unit price is lower than the unit cost. If so, the logic component obtains the status of the power source 512 from the inverter 508 and determines if the amount of produced power is higher than a sixth threshold. The status of the power source 512 comprises the produced power.

If the amount of produced power is higher than the sixth threshold, the logic component 502 controls the switch 510 such that the domestic power supply network 518 is connected to the power source 512.

If the amount of produced power is lower than the sixth threshold, the logic component 502 sets the switch 510 such that the power storage 514 is connected to the power source 512 in order to store the produced power. Alternatively, the logic component 502 controls the switch 510 such that the domestic power supply network 518 is connected to the power source 512.

If the logic component 502 determines that the unit price is higher than the unit cost based on said tariff information, the logic component 502 controls the switch such that the power source 512 is connected to the public power grid 520 in order to supply power to the public power grid 520.

Another application possibility is to use embodiments of the invention for automatic billing. The provider unit 522 sends a command to the apparatus 501 via power line communication module 526 instructing the apparatus 501 to determine and send an energy report. The energy report comprises for example, in case of a solar power source, the status of each solar module, the produced power from each solar module. Thus, it is detected by the logic component 502 if at least one module does not work correctly and an error message can be output via a user interface and/or a maintenance signal can directly be sent to the provider unit 522 via power line communication module 504. Then, the provider may analyze the problem and decide to repair the solar module which is not working correctly.

The command for sending the energy report is received by the power line communication module 504 which passes it on to the logic component 502. The logic component 502 determines the amount of energy provided to the public power grid 520 by determining the total time duration the switch 510 has been such that power has been supplied to the public power grid 520, and the amount of energy produced during this time which it gets from the inverter 508.

The logic component 502 determines the amount electrical energy consumed from the public power grid from the electric meter 517. The logic component 502 sends the energy report to the provider logic 524 via power line communication modules 504 and 526 including the amount of energy provided to the public power grid 520 and the amount of energy consumed from the public power grid 520. The provider logic 524 generates a bill for the owner of the apparatus 501 and sends this bill to the owner via the power line communication module 524

In one embodiment the provider unit 522 specifies a time period for which the logic component 502 should provide the energy report and the logic component 502 calculates the amount of energy produced and consumed for this time period.

If the public power grid 520 has no power, for example due to a blackout or if the connection to the public power grid 520 is cut, the logic component 502 checks if the load status of the power storage 514 is above the fifth threshold. If so, the logic component controls the switch 510 such that the power storage 514 is connected to the domestic power supply network 518 for supplying power to the local electrical devices. Additionally, the power source 512 may also be connected to the power storage 514 for supplying power to the power storage 514.

If the load status of the power storage 514 is below the fifth threshold, the logic component 502 controls the switch 510 such that the power storage 514 is connected to the power source 512 for recharging the power storage 514.

FIG. 2 is a schematic view of a plurality of apparatuses 501 as described above. The plurality of apparatuses 501 as shown in FIG. 2 might be installed in a plurality of households or industrial solar power providers, all connected via the public power grid 520 to the provider unit 522 forming a network 600 as shown in FIG. 2.

All apparatuses 501 comprise a power line communication module 504 which is able to send and receive data via the public power grid 520. The provider unit 522 also comprises a power line communication module 526 which is able to send and receive data via the public power grid 522. In this way, the provider unit 522 and the apparatuses 501 are able to communicate and exchange commands and data.

In operation, all apparatuses 501 are adapted to perform the methods described above. Additionally, the apparatuses 501 are also adapted to recharge the power storage 514 of another apparatus 501. This is advantageous when the logic component 502 decides to supply power to the power storage 514 although there is no more storage capacity in the power storage 514. Then, the logic component 502 controls the switch 510 such that the power source 512 is connected to the public power grid 520. Via the power line communication module 504 the provider unit 522 and the other apparatus 501 are informed that additional power is being supplied to the public power grid 520 in order to be stored in power storage 514 of the other apparatus 501. The logic component 502 of the other apparatus 501 then controls the switch 510 in the other apparatus 501 such that the power storage 514 is connected to the public power grid 520 and power is stored in the power storage 514 of the other apparatus 501.

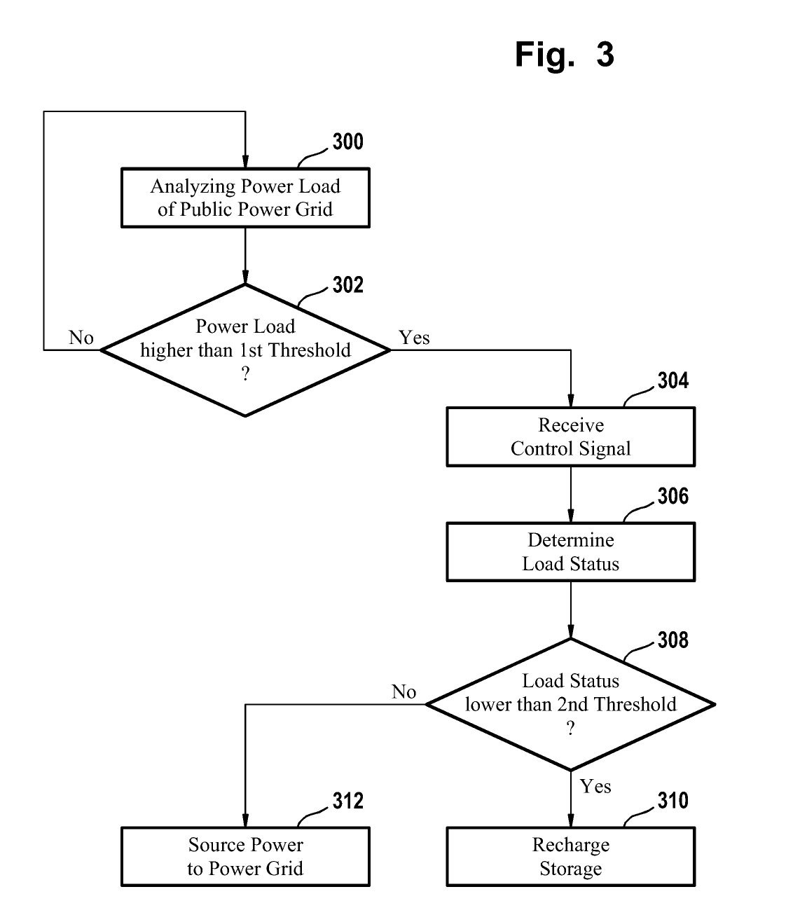

FIG. 3 is a block diagram of a peak load management method. In step 300 the power load of the public power grid is analyzed. Preferably, this is done by the provider unit. In step 302 it is determined if the power load is higher than a first threshold. If not, the provider unit analyzes again in step 300 the power load.

If the power load is higher than the first threshold, the provider unit sends a control signal, which is received by the apparatus in step 304. Then, in step 306, the logic component determines the load status of the power storage. If the load status is lower than a second threshold, the logic component controls in step 310 the switch such that the power storage and the power source are connected in order to recharge the power storage. If the load status is not lower than the second threshold, the logic component controls the switch in step 312 such that the public power grid is connected to the power source in order to supply power to the public power grid. Additionally, the power storage may also be connected to the public power grid if, for example, the power produced by the power source is not sufficient.

According to embodiments of the invention the apparatus comprises a user interface. The user may override the decision of the logic component of how to set the switch. If, for example, the user wants the power source to supply the local electrical devices, he may decide to control the switch such that the power source is connected to the domestic power supply network. If the switch is controlled according to the user's decision, an eventual control signal is ignored by the logic component. This feature would be an override control by the user.

In the drawings and specifications there has been set forth a preferred embodiment of the invention and, although specific terms are used, the description thus given uses terminology in a generic and descriptive sense only and not for purposes of limitation.

What is claimed is:

1. An apparatus comprising:
a first connector which connects to a public power grid;
a second connector which connects to a power source;
a third connector which connects to a power storage;
a fourth connector which connects to a domestic power supply network;
a controllable switch coupled to said first, second, third and fourth connectors;
a power line communication module which establishes a communication link via the public power grid, the power line communication module receiving a control signal;
a logic component coupled to said power line communication module and to said controllable switch, the logic component operating to process the control signal and perform one of the following steps depending on a result of the processing of the control signal:
setting said controllable switch to connect the power source to the public power grid and source power to the public power grid;
setting said controllable switch to connect the power source to the power storage and source power to the power storage;
setting said controllable switch to connect the power source to the domestic power supply network;
setting said controllable switch to connect the power storage to the domestic power supply network;
setting said controllable switch to connect the power storage to the public power grid and source power to the public power grid; and
setting said controllable switch to connect the public power grid to the domestic power supply network.

2. The apparatus of claim 1 wherein the power source is a renewable power source.

3. The apparatus of claim 1 further comprising a grid load measurement module which measures the grid load of the public power grid by measuring the frequency of the public power grid.

4. The apparatus of claim 1 wherein the control signal comprises a power schedule, the power schedule being indicative of periodical times of various power load levels of the public power grid.

5. A method comprising:
managing electrical power load by linking together a public power grid, a power source, a power storage, and a domestic power supply network through a controllable switch;
receiving a control signal indicative of power load circumstances; and
setting the controllable switch in a selected one of the following connective arrangements in response to the control signal, the connective arrangements comprising:
setting the controllable switch to connect the power source to the public power grid and source power to the public power grid;
setting the controllable switch to connect the power source to the power storage and source power to the power storage;
setting the controllable switch to connect the power source to the domestic power supply network;
setting the controllable switch to connect the power storage to the domestic power supply network;
setting the controllable switch to connect the power storage to the public power grid and source power to the public power grid; and
setting the controllable switch to connect the public power grid to the domestic power supply network.

6. The method of claim 5, further comprising determining a time interval in which a power line communication module has not received a control signal, and requesting a power grid status of the public power grid if the time period is longer than a threshold.

7. The method of claim 6, wherein the request of the power load status of the public power grid is communicated to a public power grid provider.

8. The method of claim 6, wherein the request of the power load status of the public power grid is communicated to a grid load measurement module.

9. The method of claim 5, the method further comprising:
receiving a power schedule, the power schedule being indicative of periodic times of various power load levels of the public power grid.

10. Apparatus comprising
a computer readable media which stores computer instructions; and
computer instructions stored on said media accessibly to the logic component of an electrical power management device which links together a public power grid, a power source, a power storage, and a domestic power supply network through a controllable switch, the instructions when executing on the logic component:
receiving a control signal indicative of power load circumstances; and
setting the controllable switch in a selected one of the following connective arrangements in response to the control signal, the connective arrangements comprising:
setting the controllable switch to connect the power source to the public power grid and source power to the public power grid;
setting the controllable switch to connect the power source to the power storage and source power to the power storage;
setting the controllable switch to connect the power source to the domestic power supply network;
setting the controllable switch to connect the power storage to the domestic power supply network;
setting the controllable switch to connect the power storage to the public power grid and source power to the public power grid; and
setting said controllable switch to connect the public power grid to the domestic power supply network.
